(19) United States
(12) Patent Application Publication
(10) Pub. No.: US 2008/0073286 A1
(43) Pub. Date: Mar. 27, 2008

(54) Waste liquid processing method in semiconductor manufacturing process and substrate processing apparatus

(76) Inventor: Eishi Shiobara, Yokohama-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/902,452

(22) Filed: Sep. 21, 2007

(30) Foreign Application Priority Data
Sep. 22, 2006 (JP) 2006-257753

(51) Int. Cl. B05C 11/10; C02F 1/00

(52) U.S. Cl. 210/744; 118/708

(57) ABSTRACT

This invention discloses a waste liquid processing method in a semiconductor manufacturing process. The waste liquids of a plurality of chemical solutions are mixed. The mixing ratio of the plurality of solutions in a waste liquid mixture generated by mixing is obtained. It is determined whether the obtained mixing ratio satisfies or is predicted not to satisfy a predetermined condition. If the mixing ratio does not satisfy or is predicted not to satisfy the condition, the waste liquid mixture is diluted with a diluent to satisfy the condition.

### CROSS-REFERENCE TO RELATED APPLICATIONS

This application is based upon and claims the benefit of priority from prior Japanese Patent Application No. 2006-257753, filed Sep. 22, 2006, the entire contents of which are incorporated herein by reference.

### BACKGROUND OF THE INVENTION

1. Field of the Invention

The present invention relates to a waste liquid processing method for various kinds of chemical solutions used in a substrate processing apparatus during a semiconductor manufacturing process, and the substrate processing apparatus.

2. Description of the Related Art

Along with micronization of semiconductor devices, various chemical solutions are used in a semiconductor device manufacturing method. In, e.g., a lithography process, solutions to form an anti-reflection film and thinners to rinse them are used in addition to resist solutions. Recently, solutions to form a protective film on a resist are used in immersion lithography.

A substrate processing apparatus called a resist coater/developer continuously executes processes such as coating, heating, cooling, and developing for these solutions. The remainder of the solutions used in these processes or solutions used to pass the solutions to the apparatus are directly discharged as waste liquids to a waste liquid tank in the apparatus or a waste liquid line in the factory.

In many cases, the waste liquids are mixed in the apparatus or in the waste liquid tank or waste liquid line and discarded. When the waste liquids mix, and their mixing ratio exceeds a specific value (solidification mixing ratio), polymer components in the solutions may solidify. Hence, the use amount of each process solution is conventionally determined in consideration of the solidification mixing ratio.

However, if the use amounts of solutions have changed from the initial set amounts, waste liquids more than the mixing ratio may be discharged. In this case, the waste liquids solidify and clog the drain or waste liquid line (e.g., Jpn. Pat. Appln. KOKAI Publication No. H07-50236).

### BRIEF SUMMARY OF THE INVENTION

According to a first aspect of the present invention, there is provided a waste liquid processing method in a semiconductor manufacturing process, comprising mixing waste liquids of a plurality of chemical solutions used in the semiconductor manufacturing process, obtaining a mixing ratio of the plurality of chemical solutions in a waste liquid mixture generated in the mixing waste liquids, determining whether the obtained mixing ratio satisfies a predetermined condition or is expected not to satisfy the predetermined condition, and diluting the waste liquid mixture with a diluent to satisfy the condition if it is determined in the determining that the mixing ratio does not satisfy or is predicted not to satisfy the condition.

According to a second aspect of the present invention, there is provided a waste liquid processing method in a semiconductor manufacturing process, comprising mixing waste liquids of a plurality of chemical solutions used in the semiconductor manufacturing process, obtaining a mixing ratio of the plurality of chemical solutions in a waste liquid mixture generated by the mixing waste liquids, determining whether the obtained mixing ratio satisfies a predetermined condition or is expected not to satisfy the predetermined condition, and controlling a mixing ratio of the waste liquid mixture to satisfy the condition if it is determined in the determining that the mixing ratio does not satisfy or is expected not to satisfy the condition.

According to a third aspect of the present invention, there is provided a substrate processing apparatus comprising a mixing unit configured to mix waste liquids of a plurality of chemical solutions used in a semiconductor manufacturing process, an arithmetic unit configured to obtain a mixing ratio of the plurality of chemical solutions in a waste liquid mixture generated by the mixing unit, a determination unit configured to determine whether the mixing ratio obtained by the arithmetic unit satisfies or is predicted not to satisfy a predetermined condition, and a diluting unit configured to dilute the waste liquid mixture with a diluent to satisfy the condition if the determination unit determines that the mixing ratio does not satisfy or is predicted not to satisfy the condition.

### BRIEF DESCRIPTION OF THE SEVERAL VIEWS OF THE DRAWING

FIG. 1 is a view showing the schematic arrangement of a substrate processing apparatus which executes a waste liquid processing method in a semiconductor manufacturing process according to the first embodiment of the present invention;

FIG. 2 is a flowchart illustrating the waste liquid processing method in the semiconductor manufacturing process according to the first embodiment;

FIG. 3 is another flowchart illustrating the waste liquid processing method in the semiconductor manufacturing process according to the first embodiment;

FIG. 4 is a still another flowchart illustrating still the waste liquid processing method in the semiconductor manufacturing process according to the first embodiment; and

FIG. 5 is a view showing the schematic arrangement of a substrate processing apparatus which executes a waste liquid processing method in a semiconductor manufacturing process according to the second embodiment of the present invention.

### DETAILED DESCRIPTION OF THE INVENTION

### First Embodiment

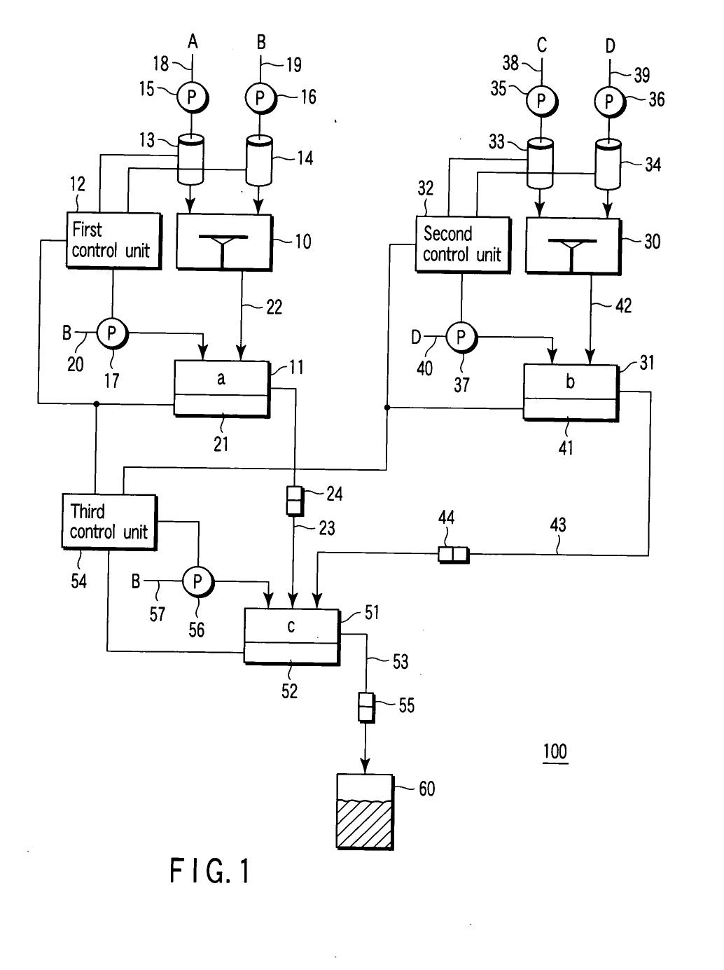

FIG. 1 is a view showing the schematic arrangement of a substrate processing apparatus 100 which executes a waste liquid processing method in a semiconductor manufacturing process according to the first embodiment of the present invention.

The substrate processing apparatus 100 includes a first process tank 10, second process tank 30, first waste liquid reservoir 11, second waste liquid reservoir 31, third waste liquid reservoir 51, flow rate sensors 13, 14, 33, and 34, first control unit 12, second control unit 32, third control unit 54, weight sensors 21, 41, and 52, pumps 15, 16, 17, 35, 36, 37, and 56, pipes 18, 19, 20, 22, 23, 38, 39, 40, 42, 43, 53, and 57, valves 24, 44, and 55, and waste liquid tank 60.

A chemical solution A is sent by the pump 15 to the first process tank 10 through the pipe 18 and used. A chemical solution B is sent by the pump 16 to the first process tank 10 through the pipe 19 and used. A chemical solution C is sent by the pump 35 to the second process tank 30 through the pipe 38 and used. A chemical solution D is sent by the pump 36 to the second process tank 30 through the pipe 39 and used.

The first control unit 12 monitors the amount of solution A passing through the pipe 18 via the flow rate sensor 13 and the amount of solution B passing through the pipe 19 via the flow rate sensor 14. The second control unit 32 monitors the amount of solution C passing through the pipe 38 via the flow rate sensor 33 and the amount of solution D passing through the pipe 39 via the flow rate sensor 34.

A waste liquid a of solutions A and B used in the first process tank 10 passes through the pipe 22 and accumulates in the first waste liquid reservoir 11. A waste liquid b of solutions C and D used in the second process tank 30 passes through the pipe 42 and accumulates in the second waste liquid reservoir 31.

The first waste liquid reservoir 11 has the weight sensor 21. The first control unit 12 and third control unit 54 monitor the weight of waste liquid a. The second waste liquid reservoir 31 has the weight sensor 41. The second control unit 32 and third control unit 54 monitor the weight of waste liquid b.

Waste liquid a in the first waste liquid reservoir 11 and waste liquid b in the second waste liquid reservoir 31 pass through the pipes 23 and 43, respectively, and mix to form a waste liquid c in the third waste liquid reservoir 51. The first control unit 12 and second control unit 32 control the flows in the pipes 23 and 43 via the valves 24 and 44, respectively. Control lines (not shown) connect the valve 24 to the first control unit 12 and the valve 44 to the second control unit 32. The third waste liquid reservoir 51 has the weight sensor 52. The third control unit 54 monitors the weight of waste liquid c.

The first control unit 12 controls the pump 17, thereby controlling the amount of solution B which passes through the pipe 20 and dilutes waste liquid a in the first waste liquid reservoir 11. The second control unit 32 controls the pump 37, thereby controlling the amount of solution D which passes through the pipe 40 and dilutes waste liquid b in the second waste liquid reservoir 31. The third control unit 54 controls the pump 56, thereby controlling the amount of solution B which passes through the pipe 57 and dilutes waste liquid c in the third waste liquid reservoir 51.

Waste liquid c in the third waste liquid reservoir 51 is discharged to the waste liquid tank 60 through the pipe 53. The third control unit 54 controls the flow in the pipe 53 via the valve 55. A control line (not shown) connects the valve 55 to the third control unit 54.

Examples of substrate processes in which the waste liquid processing method of this embodiment is executed are anti-reflection film formation on a processed substrate and resist film formation on the anti-reflection film in a lithography process. Other examples are resist film formation and immersion protective film formation on the resist film in a lithography process using an immersion lithography method.

In this embodiment, the latter case will be exemplified. Assume that solution A is a resist solution, solution B is a thinner for edge cut and back rinse, solution C is an alkali-soluble immersion protective film solution, and solution D is a thinner for edge cut and back rinse.

When a solution is applied to a substrate and spread over it by rotating the substrate, a thick film is formed at the periphery of the substrate. Edge cut is a process of planarizing the thick film. Back rinse is a process of washing off a solution from the lower surface of a substrate.

Solutions A, B, C, and D may be different, or some of them, e.g., solutions B and D, may be identical.

The alkali-soluble immersion protective film solution (solution C) used to form an immersion protective film is required to have properties not to dissolve the resist in coating on the resist. For this reason, when this solution mixes with the resist solution (solution A), the resist may be deposited. A state wherein a solid content in a waste liquid is deposited, or the fluidity of a waste liquid decreases, and the discharge pipe is clogged with the waste liquid is called “waste liquid solidification”.

Taking such a state into consideration, the mixing ratio of a plurality of waste liquids which cause deposition of a solid content (to be referred to as solidification hereinafter), i.e., solidification mixing ratio is obtained. More specifically, for waste liquid mixture a of solutions A and B, a solidification mixing ratio X (=solution A/solution B) is obtained. The solidification mixing ratio X defines such a value that solidification occurs if the ratio of solution A increases beyond the value. For waste liquid mixture b of solutions C and D, a solidification mixing ratio Y (=solution C/solution D) is obtained. The solidification mixing ratio Y defines such a value that solidification occurs if the ratio of solution C increases beyond the value.

Additionally, for waste liquid c as a mixture of waste liquid mixtures a and b which satisfy the conditions not to cause solidification, a solidification mixing ratio Z (=waste liquid a/waste liquid b) is obtained. The solidification mixing ratio Z defines such a value that solidification occurs if the ratio of waste liquid b increases beyond the value.

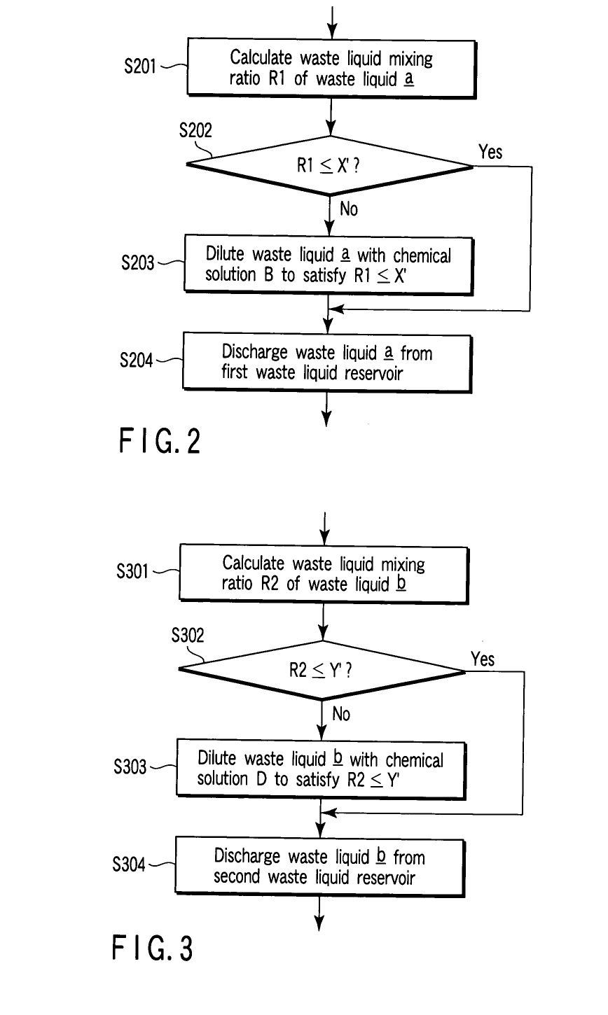

The waste liquid processing method of this embodiment will be described next with reference to the flowcharts in FIGS. 2 to 4.

First, in the first process tank 10, semiconductor substrate processes using the resist solution (solution A) and thinner (solution B) are sequentially performed. The used resist solution (solution A) and thinner (solution B) pass through the pipe 22 and mix in the first waste liquid reservoir 11.

The first control unit 12 obtains a waste liquid mixing ratio R1 of waste liquid a as a waste liquid mixture (R1=waste liquid amount of solution A/waste liquid amount of solution B) on the basis of the use amounts of the resist solution (solution A) and thinner (solution B) measured by the flow rate sensors 13 and 14, respectively (step S201 in FIG. 2).

If the amounts of solutions A and B actually consumed by the semiconductor substrate processes in the first process tank 10 are assumed to be small, the solution use amounts are assumed to equal the waste liquid amounts. Hence, waste liquid mixing ratio R1 can be obtained in the above-described way. When this assumption is correct, and the solution use amounts are preset as, e.g., pump stroke amounts in software (recipe) to control the pumps 15 and 16, waste liquid mixing ratio R1 may be calculated by using them.

However, when a volatile solution such as a thinner is used, the use amount cannot be almost equal to the waste liquid amount because of evaporation of the solution so the assumption is not correct. In this case, the first control unit 12 may obtain waste liquid mixing ratio R1 by monitoring the weight increase in the weight sensor 21 and measuring the waste liquid amount of the resist solution (solution A) and the waste liquid amount of the thinner (solution B). Waste liquid mixing ratio R1 can be obtained in this way because the process using the resist solution (solution A) and the process using the thinner (solution B) do not temporally overlap in general. In this case, waste liquid mixing ratio R1 may be obtained by causing the flow rate sensor 13 to measure the use amount of the resist solution (solution A) and the weight sensor 21 to measure the waste liquid amount of the thinner (solution B).

Next, the first control unit 12 determines whether waste liquid mixing ratio R1 obtained in step S201 satisfies a predetermined condition, i.e., whether waste liquid mixing ratio R1 is equal to or less than a set mixing ratio X′ (step S202). The set mixing ratio X′ can be equal to the solidification mixing ratio X itself. Alternatively, a margin may be set on the safe side to avoid solidification, and the set mixing ratio X′ may be set to a value smaller than the solidification mixing ratio X by the margin and held in the first control unit 12.

Note that when waste liquid mixing ratio R1 used in determination in step S202 has been obtained on the basis of solution use amounts preset in, e.g., software (recipe), it is predicted before actually mixing the waste liquids whether waste liquid mixing ratio R1 satisfies the predetermined condition.

If it is determined in step S202 that waste liquid mixing ratio R1 does not satisfy the predetermined condition, i.e., R1>X′, the first control unit 12 supplies the thinner (solution B) to the first waste liquid reservoir 11 by controlling the pump 17, thereby diluting waste liquid a and reducing waste liquid mixing ratio R1 to X′ or less (step S203).

After step S203, or if it is determined in step S202 that R1≦X′ is satisfied, waste liquid a is discharged from the first waste liquid reservoir 11 (step S204). This discharge is done by causing the first control unit 12 to control the valve 24 on the pipe 23.

Next, in the second process tank 30, semiconductor substrate processes using the immersion protective film solution (solution C) and thinner (solution D) are sequentially performed. The used immersion protective film solution (solution C) and thinner (solution D) pass through the pipe 42 and mix in the second waste liquid reservoir 31.

The same process as that for the first process tank 10 is executed in accordance with the flowchart in FIG. 3. A waste liquid mixing ratio R2=waste liquid amount of solution C/waste liquid amount of solution D. A set mixing ratio Y′ can be equal to the solidification mixing ratio Y itself. Alternatively, a margin may be set on the safe side to avoid solidification, and the set mixing ratio Y′ may be set to a value smaller than the solidification mixing ratio Y by the margin.

When the processes shown in the flowcharts of FIGS. 2 and 3 finish, waste liquid a discharged from the first waste liquid reservoir 11 and waste liquid b discharged from the second waste liquid reservoir 31 mix to form waste liquid c in the third waste liquid reservoir 51.

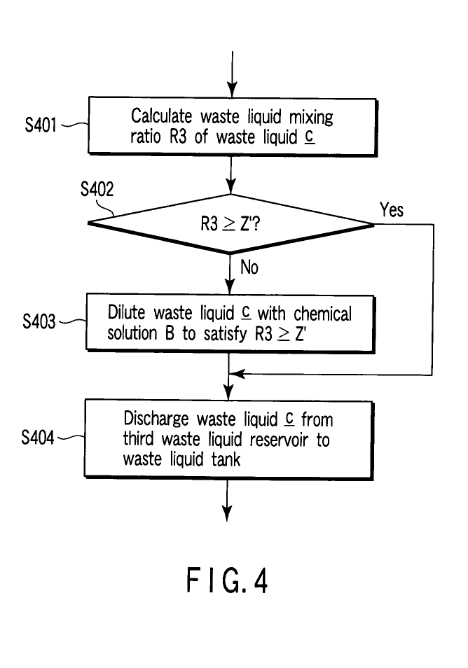

The third control unit 54 obtains a waste liquid mixing ratio R3 of waste liquid c as a waste liquid mixture (R3=amount of waste liquid a/amount of waste liquid b) on the basis of the amounts of waste liquids a and b estimated by measuring the weight decease in the weight sensors 21 and 41 or the weight increase in the weight sensor 52 (step S401 in FIG. 4).

Waste liquid mixing ratio R3 can be obtained by measuring the weight increase in the weight sensor 52 because waste liquids a and b are not simultaneously discharged from the first waste liquid reservoir 11 and second waste liquid reservoir 31 in general. Waste liquid mixing ratio R3 may be calculated by providing flow rate sensors on the pipes 23 and 43 to measure the flow rates, although not illustrated.

Next, the third control unit 54 determines whether waste liquid mixing ratio R3 obtained in step S401 satisfies a predetermined condition, i.e., whether waste liquid mixing ratio R3 is equal to or more than a set mixing ratio Z′ (step S402). The set mixing ratio Z′ can be equal to the solidification mixing ratio Z itself. Alternatively, a margin may be set on the safe side to avoid solidification, and the set mixing ratio Z′ may be set to a value larger than the solidification mixing ratio Z by the margin and held in the third control unit 54.

If it is determined in step S402 that waste liquid mixing ratio R3 does not satisfy the predetermined condition, i.e., R3<Z′, the third control unit 54 supplies the thinner (solution B) to the third waste liquid reservoir 51 by controlling the pump 56, thereby diluting waste liquid c and raising waste liquid mixing ratio R3 to Z′ or more (step S403).

As described above, the resist solution (solution A) in waste liquid a easily solidifies in the solvent used in the alkali-soluble immersion protective film solution (solution C) in waste liquid b. On the other hand, the resist solution (solution A) easily dissolves in the thinner (solution B). In this case, if waste liquid b decreases because of an increase in the immersion protective film solution (solution C), and waste liquid mixing ratio R3 decreases, the thinner (solution B) is discharged into waste liquid c.

After step S403, or if it is determined in step S402 that R3≧Z′ is satisfied, waste liquid c is discharged from the third waste liquid reservoir 51 to the waste liquid tank 60 (step S404). This discharge is done by causing the third control unit 54 to control the valve 55 on the pipe 53.

According to the waste liquid processing method of this embodiment, even when the waste liquid mixing ratio of waste liquids a, b, and c varies due to the change in the actual use amounts of the solutions, it is possible to appropriately dilute the waste liquids so no solidification occurs in the pipes 23, 43, and 53 to discharge the waste liquid mixtures. This avoids clogging in the waste liquid lines.

### Second Embodiment

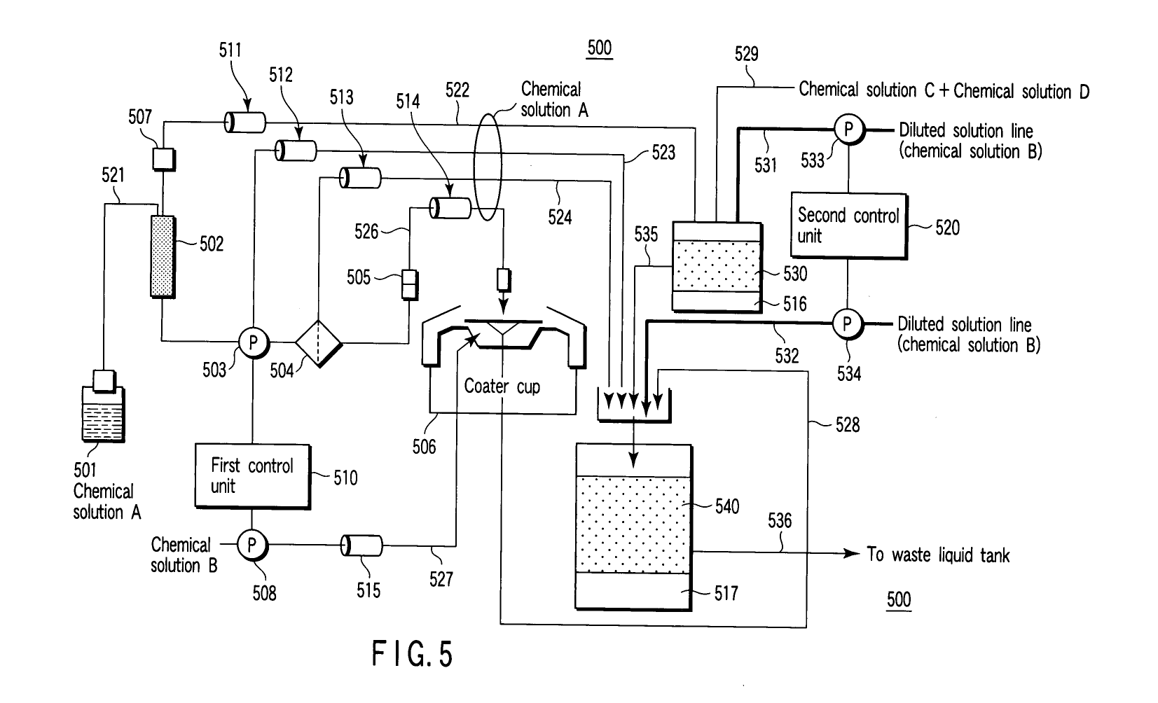

FIG. 5 is a view showing the schematic arrangement of a substrate processing apparatus 500 which executes a waste liquid processing method in a semiconductor manufacturing process according to the second embodiment of the present invention.

The substrate processing apparatus 500 includes a chemical solution bottle (solution A) 501, process tank (coater cup) 506, chemical solution reservoir 502, purge valve 507, first waste liquid reservoir 530, second waste liquid reservoir 540, flow rate sensors 511, 512, 513, 514, and 515, first control unit 510, second control unit 520, weight sensors 516 and 517, chemical solution pumps 503, 508, 533, and 534, pipes 521, 522, 523, 524, 526, 527, 528, 529, 531, 532, 535, and 536, chemical solution filter 504, and valve 505.

Solution A stored in the chemical solution bottle 501 passes through the pipe 521 and temporarily accumulates in the chemical solution reservoir 502. Solution A is then discharged by the chemical solution pump 503 on the pipe 526 onto the wafer in the process tank (coater cup) 506 through the chemical solution filter 504 and valve 505. The flow rate sensor 514 monitors the use amount of solution A.

When the purge valve 507 opens, excess solution A is discharged directly from the chemical solution reservoir 502 to the first waste liquid reservoir 530 through the pipe 522. The flow rate sensor 511 monitors the discharge amount of solution A.

Excess solution A in the chemical solution pump 503 and chemical solution filter 504 is also discharged directly to the second waste liquid reservoir 540 through the pipes 523 and 524. The flow rate sensors 512 and 513 monitor the discharge amounts of solution A.

Pipes directly connected to the waste liquid process without an intervening process tank, like the pipes 522, 523, and 524, are called drain lines. Discharge via a route different from a normal process is executed even in, e.g., passing a solution to a pipe in the substrate processing apparatus 500.

The waste liquid amounts in the drain lines are measured by using the flow rate sensors 511, 512, and 513. Alternatively, before the waste liquids mix, the waste liquid amounts may be measured by weight sensors provided in or outside the substrate processing apparatus 500. In this embodiment, measurement may be done by using the weight sensors 516 and 517.

Solution B is discharged by the pump 508 onto the wafer in the process tank (coater cup) 506 through the pipe 527. The flow rate sensor 515 monitors the use amount of solution B.

The waste liquids of solutions A and B used in the process tank (coater cup) 506 mix and are discharged to the second waste liquid reservoir 540 through the pipe 528. Already used solutions C and D are discharged, as a waste liquid mixture, to the first waste liquid reservoir 530 through the pipe 529. The waste liquid in the first waste liquid reservoir 530 is discharged to the second waste liquid reservoir 540 through the pipe 535.

The pipes 531 and 532 are diluted solution lines which dilute the waste liquids in the first waste liquid reservoir 530 and second waste liquid reservoir 540 with solution B supplied by the pumps 533 and 534.

The first control unit 510 can monitor, e.g., the flow rate sensors 511, 512, 513, 514, and 515 and the weight sensor 517 (signal lines for monitoring are not illustrated) and control the pumps 503 and 508. The second control unit 520 can monitor, e.g., the flow rate sensors 511, 512, and 513 and the weight sensors 516 and 517 (signal lines for monitoring are not illustrated) and control the pumps 533 and 534.

Examples of substrate processes in which the waste liquid processing method of this embodiment is executed are resist film formation and immersion protective film formation on the resist film in a lithography process using an immersion lithography method. Assume that solution A is a resist solution, solution B is a thinner for edge cut and back rinse, solution C is an alkali-soluble immersion protective film solution, and solution D is a thinner for edge cut and back rinse, as in the first embodiment.

Solutions A, B, C, and D may be different, or some of them, e.g., solutions B and D, may be identical.

Even in this embodiment, a solidification mixing ratio X (=solution A/solution B) of a waste liquid mixture a of solutions A and B, and a solidification mixing ratio Y (=solution C/solution D) of a waste liquid mixture b of solutions C and D are obtained in advance. Additionally, a solidification mixing ratio Z (=waste liquid a/waste liquid b) of the waste liquid mixture of waste liquid mixtures a and b under conditions not to cause solidification of them is obtained in advance.

The waste liquid processing method of this embodiment will be described below.

First, in the process tank (coater cup) 506, semiconductor substrate processes using the resist solution (solution A) and thinner (solution B) are sequentially performed. The used resist solution (solution A) and thinner (solution B) are mixed in the process tank 506 and discharged to the second waste liquid reservoir 540 through the pipe 528.

The first control unit 510 controls the amounts of the resist solution and thinner caused to flow by the pumps 503 and 508 by monitoring the flow rate sensors 514 and 515 such that waste liquid mixing ratio of the resist solution (solution A) and thinner (solution B) in the coater cup 506 becomes equal to or less than a set mixing ratio X′. Hence, the waste liquid mixture of the resist solution (solution A) and thinner (solution B) is discharged to the second waste liquid reservoir 540 without solidifying in the pipe 528.

The second control unit 520 measures the amount of excess resist solution (solution A) discharged to the first waste liquid reservoir 530 through the purge valve 507 by monitoring the flow rate sensor 511. The second control unit 520 controls the pump 533 on the basis of the measurement result, thereby supplying the thinner (solution B) from the diluted solution line 531 to the first waste liquid reservoir 530 such that the waste liquid mixing ratio of the resist solution (solution A) and thinner (solution B) in the first waste liquid reservoir 530 becomes equal to or less than the set mixing ratio X′. Hence, the waste liquid mixture of the resist solution (solution A) and thinner (solution B) is discharged to the second waste liquid reservoir 540 without solidifying in the pipe 535.

The above-described set mixing ratio X′ can be equal to the solidification mixing ratio X itself. Alternatively, a margin may be set on the safe side to avoid solidification, and the set mixing ratio XI may be set to a value smaller than the solidification mixing ratio X by the margin and held in the first control unit 510 and second control unit 520.

The second control unit 520 also measures the amount of excess resist solution (solution A) generated in the chemical solution pump 503 and chemical solution filter 504 by monitoring the flow rate sensors 512 and 513. The second control unit 520 controls the pump 534 on the basis of the measurement result, thereby supplying the thinner (solution B) from the diluted solution line 532 to the second waste liquid reservoir 540 such that the waste liquid mixing ratio of the resist solution (solution A) and thinner (solution B) flowing into the second waste liquid reservoir 540 through the pipes 523 and 524 becomes equal to or less than the set mixing ratio X′.

With the above-described process, the waste liquid mixing ratio of waste liquid mixture a of the resist solution (solution A) and thinner (solution B) in the second waste liquid reservoir 540 becomes equal to or less than the set mixing ratio X′.

When the substrate processes using the resist solution (solution A) and thinner (solution B) have finished, the second control unit 520 measures the amount of waste liquid mixture a of the resist solution (solution A) and thinner (solution B) by monitoring the weight increase in the weight sensor 517.

After the substrate processes (not shown) using the immersion protective film solution (solution C) and thinner (solution D), waste liquid mixture b is discharged from the pipe 529 to the first waste liquid reservoir 530. Assume that waste liquid mixture b is already appropriately diluted so that the waste liquid mixing ratio is equal to or less than a set mixing ratio Y′. The set mixing ratio Y′ can be equal to the solidification mixing ratio Y itself. Alternatively, a margin may be set on the safe side to avoid solidification, and the set mixing ratio Y′ may be set to a value smaller than the solidification mixing ratio Y by the margin. The second control unit 520 measures the amount of waste liquid mixture b by monitoring the weight increase in the weight sensor 516.

The second control unit 520 obtains the waste liquid mixing ratio (=amount of waste liquid a/amount of waste liquid b) of waste liquid c as a waste liquid mixture on the basis of the measured amounts of waste liquid mixtures a and b. If the waste liquid mixing ratio is less than a set mixing ratio Z′, the second control unit 520 controls the pump 533 or 534, to supply the thinner (solution B) from the diluted solution line 531 or 532, thereby diluting waste liquid c in the second waste liquid reservoir 540 and raising the waste liquid mixing ratio to Z′ or more.

This prevents solidification in the pipe 536 in discharging waste liquid c from the second waste liquid reservoir 540 to the waste liquid tank.

The set mixing ratio Z′ can be equal to the solidification mixing ratio Z itself. Alternatively, a margin may be set on the safe side to avoid solidification, and the set mixing ratio Z′ may be set to a value larger than the solidification mixing ratio Z by the margin and held in the second control unit 520.

According to the waste liquid processing method of this embodiment, even when the waste liquid mixing ratio of the waste liquids varies due to the change in the actual use amounts of the solutions, it is possible to appropriately dilute the waste liquids so no solidification occurs in the pipes 528, 535, and 536 to discharge the waste liquid mixtures. This avoids clogging in the waste liquid lines.

The prediction that the waste liquid mixing ratio of a waste liquid mixture will not satisfy a predetermined condition can be done under various circumstances, except the case described in the first embodiment in which determination is done on the basis of the set use amounts of solutions described in software (recipe).

For example, assume that a specific resist solution is used in the current lot, and a resist solution with a different solidification mixing ratio is used in the next lot. In this case, although the waste liquid mixing ratio satisfies a predetermined condition in the current process lot, it is predicted not to satisfy the predetermined condition in processing the next lot.

The substrate process procedure is described in the recipe in advance. To avoid interruption of the substrate process due to solidification of waste liquids, they may be diluted with a solution such as a thinner on the basis of the contents described in the recipe before the process of the next lot starts. Before use of the substrate processing apparatus, the liquid passages are sometimes cleaned by using a solvent with a low solubility. The solvent may also be diluted with another solution to prevent solidification before the substrate process.

When a flow rate sensor or weight sensor monitors the waste liquid amount, it is sometimes predicted on the basis of the speed of increase in the waste liquid amount read from the flow rate sensor or weight sensor that the waste liquid mixing ratio will not satisfy a predetermined condition in processing the next lot, although it satisfies the predetermined condition in the current process lot. In this case as well, the waste liquid mixture may be diluted in advance with another solution to prevent solidification of the waste liquids.

In the above-described embodiments, for example, to dilute the waste liquid mixture of the resist solution (solution A) and thinner (solution B), one of the solutions, i.e., the thinner (solution B) is used. However, if the resist solution (solution A) itself is prepared by dissolving a resist material in a unique solvent, the waste liquid mixture of the resist solution (solution A) and thinner (solution B) may be diluted with the solvent. Alternatively, solidification may be prevented by diluting the waste liquid mixture with a highly soluble solution such as cyclohexanone or γ-butyrolactone except those contained in the waste liquids.

Assume that two resist solutions are used. The two resist solutions, i.e., solutions E and F use unique solvents e and f, respectively. If solvent e is excessive, the resist material of solution F is deposited. If solvent f is excessive, the resist material of solution E is deposited. In the waste liquid mixture of the two resist solutions, if the use amounts of solutions E and F do not balance, they may be diluted by adding one of solvents e and f as needed. This balances the solvents and prevent solidification.

As described above, according to one aspect of the present invention, it is possible to provide a waste liquid processing method in a semiconductor manufacturing process and a substrate processing apparatus, which prevent solidification in a waste liquid mixture discharge pipe even when the use amounts of solutions vary.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A waste liquid processing method in a semiconductor manufacturing process, comprising:
mixing waste liquids of a plurality of chemical solutions used in the semiconductor manufacturing process;
obtaining a mixing ratio of the plurality of chemical solutions in a waste liquid mixture generated in the mixing waste liquids;
determining whether the obtained mixing ratio satisfies a predetermined condition or is expected not to satisfy the predetermined condition; and
diluting the waste liquid mixture with a diluent to satisfy the condition if it is determined in the determining that the mixing ratio does not satisfy or is predicted not to satisfy the condition.

2. A method according to claim 1, wherein the mixing waste liquids comprises:
mixing a waste liquid of a first chemical solution with a waste liquid of a second chemical solution;
mixing a waste liquid of a third chemical solution with a waste liquid of a fourth chemical solution; and
mixing a first waste liquid mixture obtained by mixing the waste liquid of the first chemical solution with the waste liquid of the second chemical solution with a second waste liquid mixture obtained by mixing the waste liquid of the third chemical solution with the waste liquid of the fourth chemical solution.

3. A method according to claim 2, wherein the obtaining comprises:
obtaining a first mixing ratio of the waste liquid of the first chemical solution to the waste liquid of the second chemical solution in the first waste liquid mixture;
obtaining a second mixing ratio of the waste liquid of the third chemical solution to the waste liquid of the fourth chemical solution in the second waste liquid mixture; and
obtaining a ratio of an amount of the first waste liquid mixture to an amount of the second waste liquid mixture in a third waste liquid mixture obtained by mixing the first waste liquid mixture with the second waste liquid mixture.

4. A method according to claim 3, further comprising:
obtaining a first value as a solidification mixing ratio at which solidification occurs when the ratio of the first chemical solution raises in the first waste liquid mixture of the first chemical solution and the second chemical solution;
obtaining a second value as a solidification mixing ratio at which solidification occurs when the ratio of the third chemical solution raises in the second waste liquid mixture of the third chemical solution and the fourth chemical solution; and
obtaining a third value as a solidification mixing ratio at which solidification occurs when the ratio of the second waste liquid mixture raises in the third waste liquid mixture obtained by mixing the first waste liquid mixture with the second waste liquid mixture in a state in which each of the first waste liquid mixture and the second waste liquid mixture satisfies a condition not to cause solidification.

5. A method according to claim 4, wherein the determining comprises:
determining whether the first waste liquid mixing ratio is not more than the first value;
determining whether the second waste liquid mixing ratio is not more than the second value; and
determining whether the third waste liquid mixing ratio is not less than the third value;

6. A method according to claim 5, wherein the diluting comprises:
diluting the first waste liquid mixture when the first waste liquid mixing ratio is determined to be larger than the first value;
diluting the second waste liquid mixture when the second waste liquid mixing ratio is determined to be larger than the second value; and
diluting the third waste liquid mixture when the third waste liquid mixing ratio is determined to be smaller than the third value.

7. A method according to claim 1, wherein the diluent is one of the chemical solutions and solvents contained in the chemical solutions.

8. A method according to claim 6, wherein
the diluent to dilute the first waste liquid mixture contains the second chemical solution,
the diluent to dilute the second waste liquid mixture contains the fourth chemical solution, and
the diluent to dilute the third waste liquid mixture contains the second chemical solution.

9. A method according to claim 6, wherein the diluents to dilute the first waste liquid mixture, the second waste liquid mixture, and the third waste liquid mixture contain the second chemical solution.

10. A waste liquid processing method in a semiconductor manufacturing process, comprising:
mixing waste liquids of a plurality of chemical solutions used in the semiconductor manufacturing process;
obtaining a mixing ratio of the plurality of chemical solutions in a waste liquid mixture generated by the mixing waste liquids;
determining whether the obtained mixing ratio satisfies a predetermined condition or is expected not to satisfy the predetermined condition; and
controlling a mixing ratio of the waste liquid mixture to satisfy the condition if it is determined in the determining that the mixing ratio does not satisfy or is expected not to satisfy the condition.

11. A method according to claim 10, wherein the controlling the mixing ratio comprises:
increasing a second chemical solution in a first waste liquid mixture including a first chemical solution and the second chemical solution, when a first mixing ratio of the first waste liquid is determined to be larger than a first value;
increasing a fourth chemical solution in a second waste liquid mixture including a third chemical solution and the fourth chemical solution, when a second mixing ratio of the second waste liquid is determined to be larger than a second value; and
diluting a third waste liquid mixture when a third waste liquid mixing ratio is determined to be smaller than a third value.

12. A substrate processing apparatus comprising:
a mixing unit configured to mix waste liquids of a plurality of chemical solutions used in a semiconductor manufacturing process;
an arithmetic unit configured to obtain a mixing ratio of the plurality of chemical solutions in a waste liquid mixture generated by the mixing unit;
a determination unit configured to determine whether the mixing ratio obtained by the arithmetic unit satisfies or is predicted not to satisfy a predetermined condition; and
a diluting unit configured to dilute the waste liquid mixture with a diluent to satisfy the condition if the determination unit determines that the mixing ratio does not satisfy or is predicted not to satisfy the condition.

13. An apparatus according to claim 12, wherein the mixing unit comprises:
a first process tank;
a first pump which sends a first chemical solution to the first process tank;
a second pump which sends a second chemical solution to the first process tank;
a first waste liquid reservoir which stores a first waste liquid from the first process tank;
a second process tank;
a third pump which sends a third chemical solution to the second process tank;
a fourth pump which sends a fourth chemical solution to the second process tank;
a second waste liquid reservoir which stores a second waste liquid from the second process tank; and
a third waste liquid reservoir which mixes the first waste liquid supplied from the first waste liquid reservoir with the second waste liquid supplied from the second waste liquid reservoir.

14. An apparatus according to claim 13, which further comprises a measuring unit configured to measure an amount of the waste liquid of each of the chemical solutions to be mixed, and
in which the arithmetic unit obtains the mixing ratio by using a measurement result from the measuring unit.

15. An apparatus according to claim 14, wherein the measuring unit comprises at least one of a flow rate sensor and a weight sensor.

16. An apparatus according to claim 14, wherein the arithmetic unit comprises:
a first control unit which obtains a waste liquid mixing ratio of a first waste liquid mixture on the basis of use amounts of the first chemical solution and the second chemical solution which are measured by the measuring unit and determines whether the waste liquid mixing ratio is not more than a first set mixing ratio;
a second control unit which obtains a waste liquid mixing ratio of a second waste liquid mixture on the basis of use amounts of the third chemical solution and the fourth chemical solution which are measured by the measuring unit and determines whether the waste liquid mixing ratio is not more than a second set mixing ratio; and
a third control unit which obtains a waste liquid mixing ratio of a third waste liquid mixture on the basis of amounts of the first waste liquid mixture and the second waste liquid mixture which are measured by the measuring unit and determines whether the waste liquid mixing ratio is not less than a third set mixing ratio.

17. An apparatus according to claim 16, wherein the measuring unit comprises at least one of a flow rate sensor and a weight sensor.

18. An apparatus according to claim 16, wherein the diluting unit dilutes the third waste liquid mixture with the diluent when the third control unit determines that the waste liquid mixing ratio of the third waste liquid mixture is lower than the third set mixing ratio.

19. An apparatus according to claim 16, which further comprises:
a process tank to which the first chemical solution and the second chemical solution are supplied;
a first waste liquid reservoir to which the waste liquid of the third chemical solution and the waste liquid of the fourth chemical solution are discharged; and
a second waste liquid reservoir to which the waste liquid of the first chemical solution, the waste liquid of the second chemical solution, and the waste liquid in the first waste liquid reservoir are discharged, and
in which the arithmetic unit comprises:
a first control unit which controls the amounts of the first chemical solution and the second chemical solution to reduce the waste liquid mixing ratio of the first chemical solution and the second chemical solution in the process tank to not more than the set mixing ratio; and
a second control unit which measures an excess amount of the first chemical solution and supplies the second chemical solution to the first waste liquid reservoir to reduce the waste liquid mixing ratio of the first chemical solution and the second chemical solution in the first waste liquid reservoir to not more than the set mixing ratio.

20. An apparatus according to claim 19, wherein the diluting unit dilutes the waste liquid mixture in the second waste liquid reservoir with the diluent when the second control unit determines that the waste liquid mixing ratio of the waste liquid mixture is lower than the set mixing ratio.
